(19) United States
(12) Patent Application Publication
(10) Pub. No.: US 2012/0095955 A1
(43) Pub. Date: Apr. 19, 2012

(54) FACILITATING RELATIONSHIPS AND INFORMATION TRANSACTIONS

(76) Inventor: Arun Darlie Koshy, Victoria (AU)

(21) Appl. No.: 12/921,364

(22) PCT Filed: Mar. 6, 2009
(86) PCT No.: PCT/AU2009/000267

§ 371 Date: Feb. 8, 2011

(30) Foreign Application Priority Data
Mar. 6, 2008 (AU) 2008901079

(51) Int. Cl. G06N 5/02

(52) U.S. Cl. 706/55

(57) ABSTRACT

A network includes at least one relational grid with nodes with each node in the relational grid having an opinion about all other nodes in the grid, including the datum and associated interpretation held by each other node, with the opinions of nodes about a given node in the relational grid being independent.

This invention relates to portable, extensible computational model of trust, reputation, information shaping to facilitate relationships and information transactions within a relational grid. It also enables management and protection of data as attributes.

In the specification we make use of various terms which are defined as follows:

### Definition: Relational Grid

A network that can be defined using graph theory and has social, conceptual or semantic implications.

Reputation is the opinion held by a node about another node (including the datum and associated interpretation held by it) on the relational grid. Each of these nodes could have differing opinions about a given node based on their own individual interactions. Fundamentally, SOR models the real world with all its complexity due its mathematically nuanced approach in dealing with subjective opinions

The following explains the basic conceptual underpinning of the relational grid as it maps to a real network:

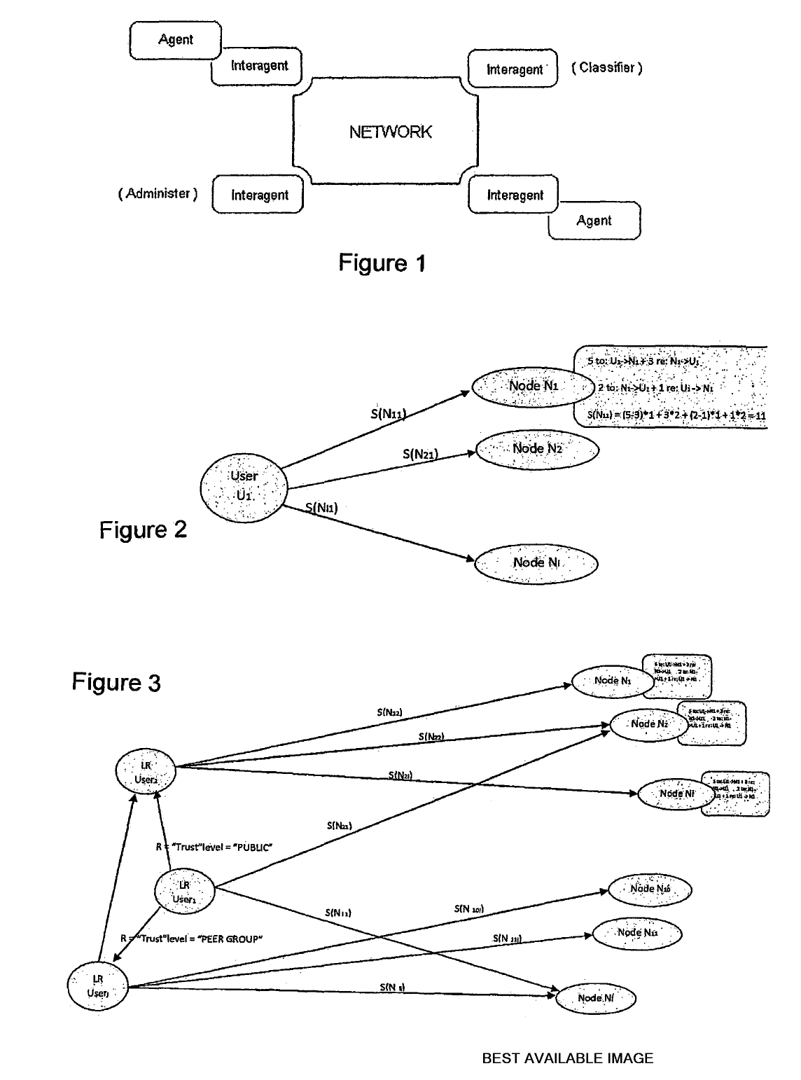

FIG. 1

An agent can be an inter-agent which manages communication and co-ordination between an agent and its relational grid

The above describes the essential architecture and has some inter-agents that perform classification functions and others that are administrative.

The network is a collection of relational grids

Agents can also provide statistical views and analytics to an administrator

The network is a separate entity to the monitoring/enforcement systems

There can be many layers of inter-agents to provide the necessary support to the architecture.

### Definition: Outcome

The outcome is defined as the result of an interaction between two nodes to allow an action and (or generate) (or accept) a set of terms/conditions/a-prior knowledge. Set O denotes all possible outcomes. We note groups of nodes with upper-case letters, (A,B . . . ) and agents with indexed lower-case letters (a₂, b₃, . . . ). A node noted bᵢ is assumed to belong to group B. We note by A the set of all node identifiers.

### Definition: Impression

An impression is defined as the evaluation made by a node on a certain aspect of an outcome. The representation used is a tuple of the form:

l =(a,b,o,φ,t,W)

where a,bεA are the nodes who are interacting (a doing the judging), oεO is the outcome, φ the variable of the outcome that is judged, t is the time when the impression is recorded, and Wε(−1, 1) represents the opinion of node a with respect to φ for that particular o.

We note by I the set of all possible impressions and node a's impressions database by IDB^{a}⊂I. We define IDB^{a}ₚ⊂IDB^{a} as the set of impressions in IDB^{a} that satisfy the pattern p, where the general form for a pattern is:

((a,b,o,φ,t,W) I condition)

with condition as a logical formula in FOL (first order logic) over components of the impression. The ‘_’ symbol is used to represent an ‘ignore’ (or don't care/unimportant) value.

Definition: Vertex Reputation

It is computed directly from the node's impressions database. An individual reputation at time t from node a's point of view and satisfying pattern p is noted as R^{t}(IDB^{a}ₚ). To calculate the individual reputation, a weighted mean of the impressions rating factors is taken giving more relevance to recent events:

$${R}^{t} ( {IDB}_{p}^{a} ) = {\sum }_{{t}_{i} ∈ {IDB}_{p}^{a}} ρ ( t , {t}_{i} ) \cdot {W}_{i}$$

where

$$ρ ( t , {t}_{i} ) = \frac{f ( {t}_{i} , t )}{{\sum }_{{t}_{j} ∈ {IDB}_{p}^{a} f ( {t}_{j} , t )}} ,$$

and f(tᵢ,t) is a time dependent function that gives higher values to values closer to t. We use the notation R_{a→b}(φ) to represent R^{t}(IDBₚ^{a}) where p={(a, b, _, φ, _, _)|true} and t is the current time.

We also use further methods to define the reliability of the reputations in the impressions database. It is represented as a convex combination.

### Definition: Social Reputation

A node inherits the reputation of the group it belongs to. This models real world behavior where a node usually inherits the reputation of the group (s)he belongs to.

Three values are computed:
Interaction with other members of the group to which the node belongs to along with the associated reliability value
What the other nodes of the group think about the node in question
What the others think about the other group

Finally, the reputation measure combines individual reputation with three social reputation measures as:

SR_{a→b}(φ)=ξ_{ab}·R_{a→b}(φ)+ξ_{aB}·R_{a→B}(φ)+ξ_{Ab}·R_{A→b}(φ)+ξ_{AB}·R_{A→B}(φ)

where ξ_{ab}+ξ_{aB}+ξ_{Ab}+εAB=1. The reliability SRL_{a→b} can be calculated similarly.

### Definition: Ontological Dimension

We can also combine reputations on different concepts. This is done by combining reputations on different concepts. To do this, an ontology is defined via a cyclic graph structure. The reputation of vertex I on the graph is then computed by the following formula:

$${OR}_{a \to b} ( i ) = \{ \begin{matrix}{\sum }_{j ∈ children ( i )} {w}_{ij} \cdot {OR}_{a \to b} ( j ) & if children ( i ) \neq Ø \\ {SR}_{a \to b} ( i ) & otherwise\end{matrix}$$

### Definition: Information Transfiguration

Information within the grid needs to be shaped to enable measurement and flow-control. For this we use our own methods of “scraping ”. This allows relevant transforms to be applied to the node's I/O. Further description of this is available in the information tagging and classification specification. These functions and processes are defined as “Information Transfiguration”.
Mitigate sparse and incomplete meta-data
Independent to content analysis and computationally inexpensive.
Assist memetic information transactions via several algorithms (e.g. that is most close to implementation—activation algorithms)

Mandate Table: Present day example (without SOR/R-Model columns - all are extensible)

| | | file objects | e-mails | IM contacts | Subsystems |
|---|---|---|---|---|---|
| Label | Users | [original location] | [destination] | [destination] | [destination] |
| Private | Admin, | C:\TopSecret\* | admin@lightr.com | admin | |
| | User1 | | | | |
| Peer | User1 | D:\Work\* | ss@ss.com, ss@ss.net | Target1 | Network, |
| Group | | | | | Printer |
| Public | User1 | C:\Documents & | 22@yahoo.com | Target2 | USB devices |
| | | Settings\User1\My | | | (FS mounted) |
| | | Documents\*.doc | | | |
| Default | | | 33@gmail.com | | |

### Premises

The system would be most beneficial within information grids where temporary virtual organizations are the norm. It can also be set at varying levels of permanence and may be extended for permanent use.

The reputation primitives are content aware. A node can be a document, file or communication vector. Network methods are also taken into account while calculating SOR/R-Model measurements (details are not given here for brevity)

Communication vector=any user owned resource that functions as an ID. Vector here is the mathematical concept.

Example: if two users are communicating (U1 and U2), if U2 had a lower score, U1 has higher score—the trust position would change if U1 suddenly allows access or communicates more+refers to a high reputation/trust document

Each business process that generates events and modifies task lists is put through a sieve of programmable methods. The finish and start point of these tasks should also influence trust/rep scores

Appropriate scaling functions are used for the formulae used so that the model works at all load levels.

We work with the notion of “information transactions”. At an atomic level, there are three types of transactions (some may not be applicable depending on context):
Contracts: In this context, a contract is not necessarily a formal contract. It can be just an agreement between two nodes
Fulfillments: i.e. the results of contracts. For instance, in a Law-firm, these may be discussions about a case between the clients and the lawyers within the firm.
Informers' communication: information about a given node (or set of nodes) of the grid coming from other nodes (or node—informer(s)). The transmitted information can be related to three different aspects: the image that the informer has of the target, the image that according to the Informer other agents have of the target (third party image) and finally the reputation of the target, which will contribute to the building of a shared mathematical state of a given SOR algorithm

Once fully developed and appropriately deployed, the SOR/R-Model can:
Reveal abnormal edges and nodes (liars, damaged)
Differentiate between:
   Image and reputation.
   Beliefs and meta-beliefs
Filter unfair measurements and observations.
Computational system for partner selection between nodes
Disrupt courtesy equilibrium which actually is dangerous for organizations
Model real world ontology with certain nodes above review (just like in the real world, there are people who actually create the framework within which others work—for e.g. the board of a company)
Propagate positive processes and groupings (and weed out the negative).
Give mathematically defensible measurements of trust, reputation and credibility. Incorporates several advanced reputation models that works with transmitted and social knowledge.
It has a credibility module to evaluate the truthfulness of information received from third party agents.
It provides a degree of reliability for the trust, reputation and credibility values that helps the agent to decide if it is sensible or not to use them in the agent's decision making process.
It can adapt to situations of partial information and improve gradually its accuracy when new information becomes available.
It can manage at the same time different trust and reputation values associated to different behavioral aspects. Also it can combine reputation and trust values linked to simple aspects in order to calculate values associated to more complex attributes.

Facilitate three atomic information transactions:
Epistemic: accept the beliefs that form a given image or acknowledge a given reputation.
Pragmatic-Strategic: use these beliefs in order to decide whether and how to interact with another node
Memetic: transmit these beliefs to other nodes (and distribute measurements via appropriate graph theoretic structures and algorithms)

Measures against the cold-start (when system does not have enough run-time or a-priori rule-sets)

The architecture is distributed with the agents capable of being engineered with higher levels of cognitive and statistical details. It is also modular even to the point of the actual algorithms and models itself. Appropriate decoupled subsystems exist to facilitate rapid prototyping and development of the system as we get better understanding through customer feedback as well as new developments in research.

Any given node can determine in advance, the computational load and consequences that arise from needing a specific level of granularity in the given transaction. For e.g. you can take higher time hits if the decision to be made is important.

### The SOR Vision of the Invention

Every datum is represented by a tuple Dₐ consisting of vertex (could be people/processes/nodes), present location, destination and statistical tags that allow the above reputation and pattern recognition algorithms to work

The agent or the web service will indicate to the vertex whether or not it should proceed with a critical action. Based on the position of the vertex on the graph, this decision can be automatically taken by the system

A sieve function is defined as S_{f}=(R₁,R₂,R₃. . . Rₙ) (P₁P₂,P₃,Pₙ) where R are the reputation algorithms (the present choice can change depending on future developments or be replaced with a totally new algorithm devised to deal with LR's specific constraints) and P are the pattern recognition algorithms;

Sₜ is used to determine whether or not an action either by the vertex. The range of the function is determined by the type of algorithms being used. N is variable to the given circumstance.

The present location and destination of the datum is determined by the owning vertex, collaborators, ontological position.

The sieve function can be applied recursively to rapidly decide between a collision situation (where more than one iteration of the function can be relevant)

The whole protocol is stateless so all sub-systems need to provide their respective contextual support.

Present set for R=(Modified Sabater-Mir various) and n for R is 9

Present set for P={Lexicon based, Dictionary based, Offline Serial Exact, Offline Parallel Exact, On-line string search, Levenshtein distance based—parallel and serial), Approximate string search, Common superstrings, Two dimensional, Tree Pattern, Applicant's kernel method hive} and n for P is 12 but this can be expected to grow.

### ALGORITHM OF THE INVENTION

User=uniquely owned user ID

Node=messaging vector

Message=datum sent between or held within node(s)

“Trust” Table=Our Mandate Table

### Local Scanner (LR Standalone Client Side)

Make LR contacts map by scanning emails base:
For each user Uj (in common case there is Just one user as owner of machine, i.e. j==1) make map of contacts (from user Uj to each node NI)
Calculate number of user Uj interactions with each node Ni and give score S(Nij) to the each node Ni:
   message from user Uj to node Ni—adds to node score S(Nij) one point:

S(Nij)+=1
message from node NI to user Uj—adds to node score S(Nij) one point

S(Nij)+=1
totally identical messages user Uj sent to node Ni are possibly send retries—by all them add to node score S(Nij) one point:

S(Nij)+=1
message from user Uj to node Ni plus reply to this message from node Ni to user Uj—adds to node score S(Nij) two points:

S(Nij)+=2
message from node Ni to user Uj plus reply to this message from user Uj to node Ni—adds to node score S(Nij) two points:

S(Nij)+=2
message from user Uj to node Ni plus multiply replies to user Uj from node Ni—adds to node score S(Nij) three points:

S(Nij)+=3

On messages scan finished give total score to the node S(Ni)=ΣSi(Nij)
Normalize node's total score norm[S(Ni)]=S(Ni)10̂5 (If norm[S(NI)]>1 then norm[S(NI)]=1)
Final node's total score is on 0.000<1.000 range (can be used with probability formulas)

FIG. 2

Rate all nodes: give node Ni corresponding “Trust” table level

By default table has four (m==4) “trust” levels: “PRIVATE”(n==1), “PEER GROUP”(n==1000), “PUBLIC”(n==10000), “DEFAULT”(n==65534). Levels can be added in 1-65534 range.

(2)
S(Ni)=ΣSi(Nij)
Calculate Rating R of Node Ni: R=S(NI)
If score of the node S(Nij)=<4->R=65535 i.e. put to lowest “Trust” level “DEFAULT”
S(Njmax)=Max S(Nij)
If Njmax=<4 then finish calculating
[symbol] if score of the node S(Nij)>4:
   Map to level n=>norm[S(Nij)]/norm[S(Nijmax)]=>norm[65534/n]
   i.e. put to closest to calculated n value existing level example:
   S(Nij)=10; S(Njmax)=100
   norm[S(Nij)]=0,0001; norm[S(Njmax)]=0,001
   S(Nij)/S(Njmax)=0,1=>
   n=65535 (DEFAULT)
   example:
   S(Nij)=90; S(Njmax)=100
   S(Nij)/S(Njmax)=0,9=>
   n=1000 (PEER GROUP)
   example:
   S(Nij)=99; S(Njmax)=100
   S(Nij)/S(Njmax)=0,99=>
   n=1 (PRIVATE)

Pass through appropriate sieve function RI and pattern function Pi

Scanner shows near each found node Nij calculated rating and asks user to manually change node Nij rating or use auto calculated ratings to automatically put all nodes to corresponding “Trust” levels
To adjust rating (suggested to user) calculation, nodes interaction time map can be build/displayed:
User Uj Nodes Interactions Time Map

| Node | January | February | March | April | May | June | July | August | September |
|---|---|---|---|---|---|---|---|---|---|
| u1@lr.com | [symbol] | 5 | 3 | 1 | 0 | 0 | 2 | [symbol] | [symbol] |
| U2@lr.com | 0 | 0 | 0 | 3 | 4 | 3 | 1 | 0 | 0 |
| u10@lr.com | 5 | 6 | 7 | 1 | 1 | 1 | 0 | 0 | 0 |
| tech@aol.com | 0 | 0 | 0 | 0 | 0 | 0 | 1 | 1 | 1 |
| us@amazon.com | 4 | 3 | 4 | [symbol] | [symbol] | [symbol] | [symbol] | 2 | 3 |

[symbol]

indicates data missing or illegible when filed

Basing on time map user can adjust or decrease Node “Trust” rating before adding to Table levels. Auto calculated rating can be adjusted with ratio to interacted in last month (last 3) nodes.

### Server Scanner (LR Centralized Server Side)

On centralized IR server, data about all LR clients “Trust” tables can be stored together with message scan results from all LR controlled machines.

From this centralized database Nodes “social network” (or “network within network”—NWN) is built. In this network “Trust” ratings are calculated not only from single User Uj nodes interaction, but from all users Uj together. This brings more accuracy to Node Ni score S(NI) (to set rating and put on table level).

Calculate number of user Uj interactions with each node NI and give score S(Nij) to the each node NI, the same as in local version (1).

Overall Node score S(Ni) is superposition of Node scores from each LR user Uj

S(Ni)=ΣS(Nij)/j

To adjust Node score S(Ni) we can add to score (rating) calculation algorithm information about total number of LR users interacted with Node Ni (more LR users know the Node then higher Score). Also user Uj own “Trust” rating (level in “Trust” table) can be applied as weight factor when calculating overall Node Ni score.

Basing on Node score Rate all nodes and give node Ni corresponding “Trust” table level same as (2)

FIG. 3

### Extensions

Documents (files) can be auto marked (mapped) to levels using different ratios:
based on how many times they are getting attached or discussed in communication channels (e-mails/IM/social networks)
using similar documents finding as in “Auto tag indexed files”—see Tags document. i.e. documents in the same folder or similar structured, tagged, authored.
Etc.

For e.g. if two users are communicating (U1 and U2), if U2 had a lower score, U1 has higher score—the trust position would change if U1 suddenly allows access or communicates more+refers to o high reputation/trust document

### “Trust” Level Sessions

User corresponds to “Trust” level in LR table. On working he can choose to assign to his session any “Trust” level less or equal secure to his level.

Example: user is on level “PEER GROUP” (1000) he can choose to current session “DEFAULT”, “PUBLIC” or “PEER GROUP”. In any time he can switch session “Trust” level up to “PEER GROUP”.

Switching session level is done via U1 (with levels list up to his level in LR table).

During running session (one of the levels assigned) user File System rights are limited with BL-model (no write-down, no read-up).

Example: user is on lever“PEER GROUP” (1000) in LR table. By default after logon his session level is “PEER GROUP”, so he can't write to files in “Program Files” that are on “DEFAULT” (basing on B-L), when he wants to write (install something) he switches level to “DEFAULT” and is able to write (install) to “Program Files”, but he can't edit his confidential documents (as “DEFAULT” has no read/write access to “PEER GROUP” objects), so he can switch his session level back to “PEER GROUP” to edit documents.

### I—Transfigure—V 0.0.1

New Explorer Shell extension (same as “safe deletion”):

On ANY document object (folder, file or group of selected objects) user can right click to see LR options:
Edit LR tag
Index for fast LR search
Edit LR “trust” level

Edit-Insert [symbol]
Edit-Insert tag string separable by commas, in search panel (bellow) this tags string (or its subset) can be used to find this document (possibly add tag string to display in document properties and information balloon shown when file is under mouse pointer)
Tag Example: “XYZco financial report, month data, confidential”

Add to Index for Fast LR Search [symbol]
Adds to LR indexed files database (see below) for fast search queries.

Edit LR “trust” Level [symbol]
Shows: current “trust” level of object if it is covered by “trust” table and option “Change”. If object is not present in “trust” table (new or “Change” pressed)—shows drop down combo box with available levels to select (“PRIVATE”, “PEER GROUP”, . . . ), shows (prompts) auto calculated “trust level”
Extensions: shows correlated file objects map (same level for rated object, or same level with calculated prompted level for new object)

LR package will have an user interface to search file objects. Search panel has search options:

[symbol] —Include only indexed files (fast)

[symbol] —Include all files (can take long time)

[symbol] —Search file names and tags only (fast)

[symbol] —Search file names, tags and content (can take long time)

[symbol] —Use natural language to search (allows “How to program in C” like queries)

□—Save search query

Search panel has search fields:
Name [symbol]
Tags [symbol]
Author [symbol]
Date [symbol]
Last modified date [symbol]
Last accessed date [symbol]
Size [symbol]
Etc. (other document available fields like “Author”—depending from document format: MS Office document properties, Adobe pdf fields, etc.)

Search panel has “Start search” button. (changes to “stop” while search).

Search panel has “Results” field (list view) with found results and sorting options.

Search panel has “Recently used documents” tab to show last accessed documents map (to edit tags, “trust” level, browse, etc.). “Recently used documents” map is based on “filestat” LR plug in logs information.

| | January | February | March | April | May | June | July | August | Total |
|---|---|---|---|---|---|---|---|---|---|
| Most used | acc | acc | acc | acc | acc | acc | acc | acc | acc |
| Filesample01.doc | [symbol] | 5 | 3 | 1 | 0 | 0 | 2 | [symbol] | [symbol] |
| Filesample15.doc | 0 | 0 | 0 | 3 | 4 | 3 | 1 | 0 | 11 |
| LRdocument03.pdf | 5 | 6 | 7 | 1 | 1 | 1 | 0 | 0 | 21 |
| LRdocument05.pdf | 0 | 0 | 0 | 0 | 0 | 0 | 1 | 1 | 2 |
| MiscDocument.xml | 4 | 3 | 4 | [symbol] | [symbol] | [symbol] | [symbol] | 2 | 64 |

[symbol]

indicates data missing or illegible when filed

Search panel has “Auto tag indexed files” button: finds for every scanned document similar documents (in the same folder, with similar name, author, properties, etc. If some of found similar documents have tag information duplicates this tag to current file, else can add parent folder name (or its part) to document tag.

LR package will have new service for search queries (to index files and work with database). Local databases can be accessed from central LR server for server side search queries on selected remote machine or on group of selected machines.

LR package will have new (SQL driven) database to index searched files (fast search) including:
physical location of file C:\DOCUMENTS\PDF\PR.PDF
file tag string
document (folder) size
last accessed date
last modification date
document full text (if size is smaller then XYZ Kbytes)
author
other search dependent fields

### Extensions: Search Queries

Concept:
User1 searches [symbol] what is XYZ? [symbol] via a given search function
User1 actually found answer on page 15 of search result
User1 wants to share this result with other users and clicks “LR save search query & result”
Then a save query report is created and a classification methodology is applied
Automatically this information is set the part of “LR queries database” and only available to known LR nodes

Two realization alternatives:
1) Browser plug in for IE (Firefox):
   User1 searches for “XYZ”
   When User1 found answer he goes back to last search result page (15 in text above)
   He right clicks on successful link on page 15 (this linked is highlighted by browser as last visited)
   This link is stored in “LI? queries database”together with search query string (“What is XYZ?”) and cached target page (if it is small). The database is replicated to central LR server
   In future LR users can give “What is XYZ?” query to LR search panel and receive link to the found by User1 page (and cached page itself) as a result.
   Access to saved queries can be granted basing on “trust” (mandate) table level of LR users (i.e. if query is marked by User1 as confidential, then only LR users with the same level or more secret level can access results of such query: “What is XYZ?”)
2) Traffic “search queries” extraction plug in.
   User1 searches for “XYZ”
   Traffic analyzer (tcpfilter.sys+special plug in to find search queries for Google, MSN, and Yahoo) finds search request “What is XYZ?”
   When User1 found answer on page linked from Google search results page 15, he presses hotkey (or calls LR UI) to save the query
   LR pops up dialog with saved query string “What is XYZ?” (to verify it correctly extracted search string) and link to final page seen by user (LR claims user pressed hotkey on final page when result found, else user can also correct the link)
   This link is stored in “LR queries database” together with search query string (“What is XYZ?”) and cached target page (if it is small). The database is replicated to central LR server
   In future LR users can give “What is XYZ?” query to LR search panel and receive link to the found by User1 page (and cached page itself) as a result.
   Access to saved queries can be granted basing on “trust” (mandate) table level of LR users (i.e. if query is marked by User1 as confidential, then only LR users with the same level or more secret level can access results of such query: “What is XYZ?”)

### Interests & Relationships

Concept:
User1 searches [symbol] what is XYZ? [symbol] via LR search panel
LR search panel scans “LR Interests database” for people that can help (or give some information about) “XYZ” and gives user back with people contact list (people knowing about “XYZ”). This LR users linked to “interests” database is build by automated scanners (analyzing messages subjects and bodies, IM messages, social networks membership, local files tags, local files content-text, etc.)
Automatically this information is only available to known LR users (represented by e-mail/IMs etc). i.e. user can scan for contacts (of LR users) that can help him with XYZ, reuse there results and expertise about XYZ (Example “XYZ” is computer component vendor company name and User1 wants to know if this vendor is reliable or not)
   Access to “LR interests database” queries can be optionally granted basing on “trust” (mandate) table level of LR users to prevent communicating with person on more secret level (like: only LR users with the same level or more secret level can access contacts of LR user placed on level X)

### Design Principles

Data should be naturally understood by the machine and appropriate conversion functions should be applied.

To facilitate this, the system must enhance the collection and build-up of meta-data

The technology to capture such relationships is called the Resource Description Framework (RDF). The key point is that the original vision encompassed additional meta data above and beyond what is currently in the Web. This additional meta data is needed for machines to be able to process information on the Web.

Stages:

Move away from proprietary application specific context

1. XML documents for a single domain

2. Taxonomies and documents with mixed vocabularies

3. Ontologies and rules

4. Pass through appropriate sieve function Ri and pattern function PI.

1-13. (canceled)

14. A network, comprising:
at least one relational grid having a plurality of nodes, each node of said plurality of nodes in one relational grid having an opinion about each other nodes of said plurality of nodes, the opinion including datum and associated interpretation held by each said node with opinions of each said node about a given said node being independent.

15. The network according to claim 14, wherein said at least one relational is a plurality of relational grids.

16. The network according to claim 14, wherein each said relational grid includes temporary virtual organizations.

17. The network according to claim 16, wherein said temporary virtual organizations have organizations with varying levels of permanence.

18. The network according to claim 14, further comprising a trust relationship between said plurality of nodes for which a relationship is changeable as a result of change of external variables for one said node of said plurality of nodes.

19. The network according to claim 14, wherein measurement of at least one of trust, reputation and credibility between nodes of said plurality of nodes are mathematically ascertainable.

20. The network according to claim 14, wherein each piece of said datum is represented in a manner permitting use of a reputation and pattern recognition algorithm.

21. The network according to claim 14, wherein, based on the opinions between said nodes, positive processes and groupings are enhanced and negative groupings are discarded.
